(19) United States
(12) Patent Application Publication
(10) Pub. No.: US 2025/0068556 A1
(43) Pub. Date: Feb. 27, 2025

(54) Secure Shared Memory Buffer For Communications Between Trusted Execution Environment Virtual Machines

(71) Applicant: Intel Corporation, Santa Clara, CA (US)

(72) Inventors: Arie AHARON, Haifa (IL); Jiewen YAO, Shanghai (CN)

(73) Assignee: Intel Corporation, Santa Clara, CA (US)

(21) Appl. No.: 18/726,768

(22) PCT Filed: Sep. 28, 2022
(86) PCT No.: PCT/US2022/077172

§ 371 Date: Jul. 3, 2024

(30) Foreign Application Priority Data
Mar. 28, 2022 (WO) PCT/CN2022/083264

(51) Int. Cl. G06F 12/02; G06F 9/455; G06F 21/53

(52) U.S. Cl. CPC G06F 12/023; G06F 9/45558; G06F 21/53; G06F 2009/45587; G06F 2221/033

(57) ABSTRACT

A system includes memory circuitry to store a secure shared memory buffer (SSMB) and instructions; and a processor to create the SSMB in the memory circuitry and assign ownership of the SSMB to an SSMB owner, the SSMB owner being a trusted execution environment virtual machine running on the computing system; configure access permissions for the SSMB by the SSMB owner to allow one or more SSMB users to access the SSMB, the one or more SSMB users being trusted execution environment virtual machines running on the computing system; allocate memory by the SSMB owner from the SSMB owner's private memory space in the memory circuitry for the SSMB; and allowing secure access by the one or more SSMB users to the SSMB in response to successfully verifying authorization of the one or more SSMB users based at least in part on the access permissions.

### RELATED APPLICATIONS

This application claims, under 35 U.S.C. § 371, the benefit of and priority to International Application No. PCT/US2022/077172, filed Sep. 28, 2022, titled SECURE SHARED MEMORY BUFFER FOR COMMUNICATIONS BETWEEN TRUSTED EXECUTION ENVIRONMENT VIRTUAL MACHINES, which claims the benefit of and priority to PCT Provisional Application No. PCT/CN2022/083264, filed Mar. 28, 2022, the entire contents of which are incorporated herein by reference.

### FIELD OF THE DISCLOSURE

This disclosure relates generally to communications between processes in computing systems, and more particularly, to implementing a secured shared memory buffer for communications between trusted execution environment virtual machines.

### BACKGROUND

Some computing systems provide confidential computing architectures that include architectural elements to help deploy hardware-isolated, trusted execution environment (TEE) virtual machines (VMs) (TVMs). In some implementations, TVMs are called trusted domains (TDs). One example of such a confidential computing architecture is Intel® Trust Domain Extensions (Intel® TDX). TDX is designed to isolate TDs from a virtual machine manager (VMM)/hypervisor and any other non-TD software on the computing system to protect TDs from a broad range of potential software attacks.

Implementing efficient communications between TVMs that maintain confidentiality and integrity is problematic. Some approaches result in the use of extensive cryptographic software stacks, added transport layer service (TLS) connection setup and communications times, and unnecessary and potentially insecure VMM interactions.

### BRIEF DESCRIPTION OF THE DRAWINGS

FIG. 1 is a block diagram illustrating an example computing system that provides isolation in virtualized systems using TVMs according to one implementation.

FIG. 2 illustrates a computing system having a secured shared memory buffer (SSMB) for implementing efficient and secure communication between TVMs, according to an example.

FIG. 3 illustrates a secure shared memory buffer (SSMB) state machine, according to an example.

FIG. 4 is flow diagram of processing for a SSMB, according to an example.

FIG. 5 is a block diagram of an example processor platform structured to execute and/or instantiate the machine-readable instructions and/or operations of FIGS. 1-4 to implement the apparatus discussed with reference to FIGS. 1-4.

FIG. 6 is a block diagram of an example implementation of the processor circuitry of FIG. 5.

FIG. 7 is a block diagram of another example implementation of the processor circuitry of FIG. 5.

FIG. 8 is a block diagram illustrating an example software distribution platform to distribute software such as the example machine readable instructions of FIG. 5 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method, system and apparatus to improve performance of secure communications between trusted execution environment virtual machines (TVMs) in a computing system. Some implementations herein are described with respect to the confidential computing architecture of Intel® TDX, although other implementations may also be used in other confidential computing architectures including TVMs, such as AMD® Secure Encrypted Virtualization (SEV) or ARM® Realm Management Extension (RME), for example.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor” or “processing device” or “processor circuitry” or “hardware resources” are defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s). As used herein, a device may comprise processor circuitry or hardware resources.

As used herein, a computing system can be, for example, a server, a disaggregated server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, an electronic voting machine, or any other type of computing device.

In the following description, numerous specific details are set forth, such as specific application binary interface (ABI) primitives, specific operations and sequences of operations, specific Intel® Trust Domain Extensions (TDX) implementation details, and the like. However, embodiments may be practiced without these specific details. In other instances, well-known circuits, structures and techniques have not been shown in detail to avoid obscuring the understanding of the description. In other implementations, TDX may be known as a trusted execution environment (TEE) security manager (TSM).

Cloud security providers (CSPs), driven by their customers' requirements, desire cryptographic isolation for customer workloads running on their computing platforms. In some implementations, cryptographic isolation may be provided by Secure Memory Encryption (SME) and Secure Encrypted Virtualization (SEV) from Advanced Micro Devices, Inc. (AMD) to meet these requirements for the cloud providers. In other implementations, cryptographic isolation may be provided by TDX from Intel® Corporation for providing such isolation on servers and removing CSP software (e.g., virtual machine manager (VMM)) from the trust boundary. TDX provides cryptographic isolation for customer workloads in a cloud computing environment using a multi-key (MK) total memory encryption engine (TME) (MK-TME), which provides both confidentiality and integrity. While the cryptographic mechanisms implemented in the MKTME engine circuitry are used to provide confidentiality and integrity to trust domain data, they impose additional performance overheads.

In some implementations, protected TVMs may be TDs in TDX. TDX extends Virtual Machines Extensions (VMX) and MKTME with a virtual machine guest called a trust domain (TD). A TD runs in a central processing unit (CPU) mode which protects the confidentiality of the TD's memory contents and the TD's CPU state from any other software, including a VMM, unless explicitly shared by the TD itself. TDX is built on top of Secure Arbitration Mode (SEAM), which is a CPU mode and extension of the VMX instruction set architecture (ISA). The TDX module, running in SEAM mode, serves as an intermediary between VMM and the guest TDs. The VMM is expected to be TDX-aware. The VMM can launch and manage both guest TDs and legacy guest VMs. The VMM may maintain legacy functionality from the legacy VMs perspective. The VMM may be restricted regarding the TDs managed by the VMM.

Generally, a trusted execution environment security manager (TSM) (such as a TDX module in a TDX architecture) may help to provide confidentiality (and integrity) for customer (tenant) software executing in an untrusted CSP infrastructure. The TVM architecture, which can be a System-on-Chip (SoC) capability, provides isolation between TVM workloads and CSP software, such as a VMM of the computing system 101 managed by a CSP. Components of the TVM architecture may include 1) memory encryption (e.g., via a MKTME engine), 2) a resource management capability such as a VMM, and 3) execution state and memory isolation capabilities in a processor of platform hardware provided via a TSM managed Physical Address Metadata Table (PAMT) 116 and via TSM enforced confidential TVM control structures. The TVM architecture provides an ability of a processor to deploy TVMs that leverage a memory encryption engine (such as the MKTME engine), the PAMT, a Secure (integrity-protected) Extended Page Table (SEPT) and access-controlled confidential TVM control structures for secure operation of TVM workloads.

In one implementation, the tenant's software is executed in a TVM (e.g., a TD). This TVM (also referred to as a tenant TVM) refers to a tenant workload (which can comprise an OS alone along with other ring-3 applications running on top of the OS, or a VM running on top of VMM along with other ring-3 applications, for example). Each TVM may operate independently of other TVMs in the system and may use logical processor(s), memory, and I/O assigned by the VMM on the platform. Each TVM may be cryptographically isolated in memory using at least one exclusive encryption key of the memory encryption engine (e.g., MKTME engine) to encrypt the memory (holding code and/or data) associated with the TVM.

In some implementations, the VMM in the TVM architecture may act as a host for the TVMs and may have full control of the cores and other components of computing system 101 hardware. The VMM may assign software in a TVM with logical processor(s). The VMM, however, may be restricted from accessing the TVM's execution state on the assigned logical processor(s). Similarly, the VMM assigns physical memory and I/O resources to the TVMs but is not privy to access the memory state of a TVM due to the use of separate encryption keys enforced by the CPUs per TVM, and other integrity and replay controls on memory. Software executing in a TVM operates with reduced privileges so that the VMM can retain control of platform resources. However, the VMM cannot affect the confidentiality or integrity of the TVM state in memory or in the CPU structures under defined circumstances.

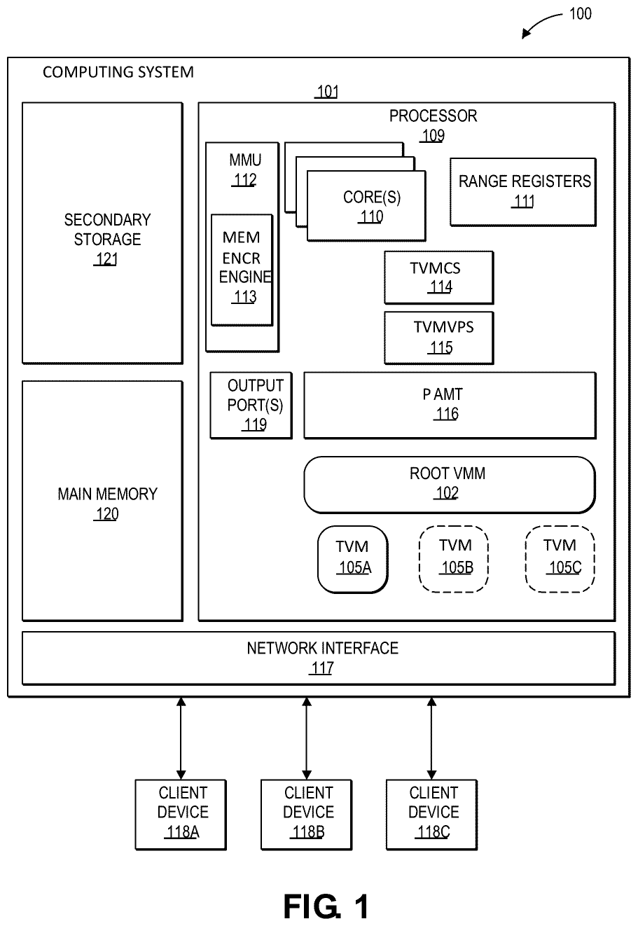

FIG. 1 is a schematic block diagram of a computing system 101 that provides isolation in virtualized systems using TVMs, according to an implementation of the disclosure. The computing system 101 supports client devices 118A-118C. Computing system 101 includes at least one processor 109 (also referred to as a processing device) that executes a root VMM 102 (which may be an implementation of a VMM). The root VMM 202 may include a VMM (which may also be referred to as hypervisor) that may instantiate one or more TVMs 105A-105C accessible by the client devices 118A-118C via a network interface 117. The client devices may include, but are not limited to, one or more of a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device.

A TVM may refer to a tenant (e.g., customer) workload. The tenant workload can include an OS alone along with other ring-3 applications running on top of the OS or can include a VM running on top of a VMM along with other ring-3 applications, for example.

The processor 109 may include one or more cores 110, range registers 111, a memory management unit (MMU) 112, and output port(s) 119, one or more TVM control structure(s) (TVMCS(s)) 114 and TVM virtual-processor control structure(s) (TVMVPS(s)) 115. The processor 109 may be used in a system that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another implementation, the processor 109 may be used in a SoC system.

The computing system 101 may be a server or other computer system having one or more processors available from Intel Corporation, AMD, Inc., or other processor developer, although the scope of the technology described herein is not so limited. In one implementation, sample computing system 101 executes a version of the WINDOWS™ operating system available from Microsoft Corporation of Redmond, Washington, although other operating systems (UNIX and Linux for example), embedded software, and/or graphical user interfaces, may also be used. Thus, implementations of the disclosure are not limited to any specific combination of hardware circuitry and software.

The one or more processing cores 110 execute instructions of the system. The processing core 110 includes, but is not limited to, pre-fetch circuitry to fetch instructions, decode circuitry to decode the instructions, execution circuitry to execute instructions and the like. In an implementation, the computing system 101 includes a component, such as the processor 109 to employ execution units including circuitry to perform processes for processing data.

Computing system 101 includes a main memory 120 and a secondary storage 121 to store program binaries and OS driver events. Data in the secondary storage 121 may be stored in blocks referred to as pages, and each page may correspond to a set of physical memory addresses. The computing system may employ virtual memory management in which applications run by the core(s) 110, such as the TVMs 105A-105C, use virtual memory addresses that are mapped to guest physical memory addresses, and guest physical memory addresses are mapped to host/system physical addresses by a MMU 112.

The core 110 may use the MMU 112 to load pages from the secondary storage 121 into the main memory 120 (which includes a volatile memory and/or a non-volatile memory) for faster access by software running on the processor 109 (e.g., on the core). When one of the TVMs 105A-105C attempts to access a virtual memory address that corresponds to a physical memory address of a page loaded into the main memory, the MMU returns the requested data. The core 110 may execute the VMM portion of root VMM 102 to translate guest physical addresses to host physical addresses of main memory and provide parameters for a protocol that allows the core to read, walk and interpret these mappings.

In one implementation, processor 109 implements a TVM architecture and ISA extensions (SEAM) for the TVM architecture. The SEAM architecture and the trusted execution environment security manager (TSM) running in SEAM mode to provide isolation between TVM workloads 105A-105C and from CSP software (e.g., a CSP VMM (e.g., root VMM 102)) executing on the processor 109). Components of the TVM architecture can include 1) memory encryption, integrity and replay-protection via a memory encryption engine 113; 2) a resource management capability referred to herein as the root VMM 102; and 3) execution state and memory isolation capabilities in the processor 109 provided via a PAMT 116 and via access-controlled confidential TVM control structures (e.g., TVMCS 114 and TVMVPS 115). The TVM architecture provides an ability of the processor 109 to deploy TVMs 105A-105C that leverage the memory encryption (mem encr) engine 113, the PAMT 116, and the access-controlled TVM control structures (e.g., TVMCS 114 and TVMVPS 115) for secure operation of TVM workloads 105A-105C.

In implementations of the disclosure, the root VMM 102 acts as a host and has control of the cores 110 and other platform hardware. A VMM assigns software in a TVM 105A-105C with logical processor(s). The VMM, however, cannot access a TVM's execution state on the assigned logical processor(s). Similarly, a VMM assigns physical memory and I/O resources to the TVMs but is not privy to access the memory state of the TVMs due to separate encryption keys, and other integrity and replay controls on memory.

With respect to the separate encryption keys, the processor may utilize the memory encryption engine 113 to encrypt (and decrypt) memory used during execution. With total memory encryption (TME), any memory accesses by software executing on the core 110 can be encrypted in memory with an encryption key. In an implementation, MKTME is an enhancement to TME that allows use of multiple encryption keys that may be implemented in memory encryption engine 113. The processor 109 may utilize the memory encryption engine to cause different pages to be encrypted using different keys. The memory encryption engine 113 may be utilized in the TVM architecture described herein to support one or more encryption keys per each TVM 105A-105C to help achieve the cryptographic isolation between different CSP customer workloads. For example, when a memory encryption engine is used in the TVM architecture, the CPU enforces by default that TVM (all pages) are to be encrypted using a TVM-specific key. Furthermore, a TVM may further choose specific TVM pages to be plain text or encrypted using different ephemeral keys that are opaque to CSP software.

Each TVM 105A-105C is a software environment that supports a software stack (e.g., using virtual machine extensions (VMX)), OSes, and/or application software (hosted by the OS). Each TVM may operate largely independently of other TVMs and use logical processor(s), memory, and I/O assigned by the VMM 102 on the platform. Software executing in a TVM operates with reduced privileges so that the VMM can retain control of platform resources; however, the VMM cannot affect the confidentiality or integrity of the TVM under defined circumstances.

Computing system 101 includes a main memory 120. Main memory includes a DRAM device, a static random-access memory (SRAM) device, flash memory device, or other memory device. Main memory stores instructions and/or data represented by data signals that are to be executed by the processor 109. The processor may be coupled to the main memory via a processing device bus. A system logic chip, such as a memory controller hub (MCH) may be coupled to the processing device bus and main memory. An MCH can provide a high bandwidth memory path to main memory for instruction and data storage and for storage of graphics commands, data and textures. The MCH can be used to direct data signals between the processor, main memory, and other components in the system and to bridge the data signals between processing device bus, memory, and system I/O, for example. The MCH may be coupled to memory through a memory interface. In some implementations, the system logic chip can provide a graphics port for coupling to a graphics controller through an Accelerated Graphics Port (AGP) interconnect.

Computing system 101 may also include an I/O controller hub (ICH). The ICH can provide direct connections to some I/O devices via a local I/O bus. The local I/O bus is a high-speed I/O bus for connecting peripherals to the memory 120, chipset, and processor 109. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

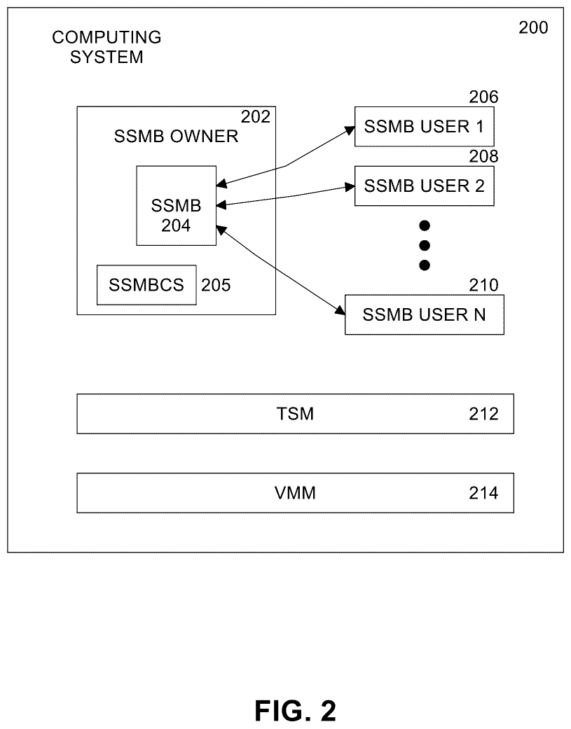

Implementations described herein improve secure communications between TVMs (such as TDs in one implementation) (such as two or more of TVM 105A, TVM 105B, and TVM 105C) by providing for a Secured Shared Memory Buffer (SSMB). A SSMB is a shared private and secure memory that may be accessed by more than one TVM. FIG. 2 illustrates a computing system 200 having a secured SSMB 204 for facilitating communication between TVMs, according to an example. In an example, computing system 200 is an instance of computing system 101 of FIG. 1, with some components omitted for clarity. In an implementation, SSMB 204 is hardware circuitry embodied in a processor of computing system 200 (such as processor 109 of computing system 101 of FIG. 1). In another implementation, SSMB 204 is embodied in software in a TD. In another implementation, SSMB 204 is embodied in one or more of main memory 120 and secondary storage 121 of computing system 200. In another implementation, SSMB 204 is a resource residing in an external device and mapped to a TVM using memory mapped input output (MMIO) operations.

In an example, SSMB 204 is instantiated in a trusted computing base (TCB) manager TVM, called a SSMB owner 202, running on computing system 200. Computing system 200 also runs trusted execution environment security manager (TSM) 212 (e.g., a collection of TVM capabilities and data structures such as TVMCS 114 and TVMVPS 115 of FIG. 1) and VMM 214 (e.g., an example of root VMM 102 of FIG. 1).

In one implementation, SSMB 2204 has the following attributes: (1) The SSMB is a portion of VM (e.g., TVM private memory) of SSMB owner 202; (2) The SSMB may be shared between multiple TVMs (e.g., TDs). (3) The SSMB 204 includes access rights (e.g., group ID to permission, Read, Write, Execute, or any other mapping attributes the SSMB owner wants to enforce such as, but not limited to, memory type (write-back (WB), write-combining (WC), un-cached memory (UC), etc.); (4) An entity, SSMB owner 202, has ownership of SSMB 204, which controls the creation, deletion, attributes, access granting and access revoking; (5) The SSMB 204 has multiple users, including two or more SSMB users, such as SSMB user 1 206, SSMB user 2 208, . . . . SSMB user N 210, where N is a natural number, which can use the SSMB 204 based upon the granted attributes; and (6) The SSMB has a page order measurement capability to ensure the order of the SSMB pages as configured by the SSMB owner 202 is preserved by the untrusted VMM 214, which maps SSBM pages to SSMB users. To ensure the SSMB is mapping in a user TVM cannot be reordered, the SSMB technology may involve ordering enforcement such reporting and measurement of the page order or other mechanisms. Generally, SSMB users may be TVMs (e.g., TDs in a TDX implementation).

The SSMB owner 202 is a special TVM. The SSMB owner 202 creates the SSMB 204 and manages and enforces access permissions with the assistance of TSM 212. A SSMB user 206, 208, . . . 210 may request access to the SSMB 204 from the SSMB owner 202 and get the access after SSMB owner 202 for verified SSMB TVM users using attestation, certificates or any other cryptographically secure mechanism. The SSMB 204 may be used for secured memory sharing in confidential computing environment. The SSMB can resolve existing issues with many applications and use cases and may also be used in other scenarios where communications between TVMs is needed.

Although described herein with respect to TDX, the SSMB may also be implemented in other confidential computing architectures such as AMD Secure Encrypted Virtualization (SEV), ARM Realm Management Extension (RME), and ARM Confidential Computing Architecture (CCA).

Implementations described herein provide technical advantages including, but not limited to, resolving disadvantages about existing TVM-to-TVM (e.g., TD-to-TD) communications approaches. Implementations herein provide a common software pattern on how to allow two confidential computing environments to communicate with each other, with special TCB support via SSMB owner 202.

The SSMB owner 202 requests VMM 214 to create the SSMB 204 and manages access permissions with the assistance of TSM 212. SSMB owner 202 indicates to other TVMs that the SSMB owner is the SSMB provider (SSMB is allocated from the private memory of the SSMB owner) and controller (the SSMB owner decides which TVM user may have access to the SSMB).

SSMB users (e.g., SSMB user 1 206, SSMB user 2 208, . . . . SSMB user N 210) may use SSMB 204. A SSMB user requests access to the SSMB 204 from the SSMB owner 202 and gets access after the SSMB owner verifies the requested SSMB user using attestation, certificates or any other cryptographically secure mechanism.

VMM 214 manages the SSMB 204 together with other memory in computing system 200. For example, the VMM can add SSMB pages to a TVM (e.g., one of the SSMB users). In the technology described herein, the threat model is unchanged, even though the VMM is outside of the trusted computing base (TCB) of the SSMB owner 202. The confidentiality and integrity of SSMB 204 will be maintained. VMM 214 can cause a denial of service (DOS) to SSMB 204 (in a manner similar to conventional private memory).

TSM 212 enforces a security policy and provides application programming interfaces (APIs) for access to SSMB 204. After SSMB owner 202 configures the SSMB 204, the access permissions of SSMB may be managed by TSM 212. TSM 212 also maintains the order of the SSMB pages and the order can be verified by a SSMB user.

The SSMB owner 202 is the owner of the SSMB 204. A binding process is utilized for the SSMB owner 202 to be able to set the SSMB user permission group and to assume trust relations between the SSMB users and the SSMB owner. As part of the binding process, the SSMB owner 202 also has the ability to decide about the identity of the SSMB users that may run in the key domain of the SSMB owner. VMM 214 builds the SSMB owner 202 to allow the SSMB owner to identify the SSMB users (reading/setting their group ID and activating them giving them the final measurement which later will be enforced by the TSM). VMM 214 builds SSMB users with a SSMB owner binding and gets SSMB user handles. VMM 214 sends SSMB user handles to SSMB owner 202. Using the handle, the SSMB owner approves the SSMB user and a group identifier (ID) for a permission group (to express memory sharing permissions per group instead of per instance).

A goal of the SSMB 204 is to enable private memory sharing between TVMs for secure and fast commination. In one implementation, the SSMB 204 is a selected ordered set of host physical address (HPA) pages allocated from the SSMB owner's private guest physical address (GPA) space. The SSMB 204 is shared explicitly by the SSMB owner 202 with the SSMB users 206, 208, . . . 210 specifying predefined access permissions.

In an implementation, security requirements of the SSMB 204 may include: (1) Structure integrity-all views of SSMB should be consistent (exact HPA order and sizes); (2) The SSMB owner controls SSMB access permission; (3) SSMB pages cannot be reclaimed from the SSMB owner while other SSMB users may be accessing the SSMB; and (4) Two SSMBs cannot share the same HPA pages (that is, the selected ordered set of host physical address pages can be allocated to only one SSMB at a time).

In an implementation, SSMB owner 202 uses SSMB control structure (SSMBCS) 205 to manage SSMB 204. SSMBCS 205 fields may include: 1) Owner-SSMB owner HPA; 2) Group Permission Table (GPT) of Group-ID to Permission (RWX) entries (for example, 16 entries); 3) Measurement (MR) (e.g., using a secure hash algorithm (SHA) SHA-384 process) of the SSMB 204 HPA and sizes as entries are added by the SSMB owner; 4) OWNER_REF_CNT-Total SSMB pages mapped in to the SSMB user's secure extended page table (SEPT), decremented on each SSMB owner page removal, and only when this counter==0, the SSMB can be reclaimed; 5) USER_REF_CNT—Total SSMB pages mapped in user(s) (e.g., SSMB users) SEPT(s), decremented on each SSMB user alias page removal, and only when this counter==0, a SSMB page mapping can be blocked/changed in the SSMB owner's SEPT; and 6) State (NULL/INIT/READY/BLOCKED).

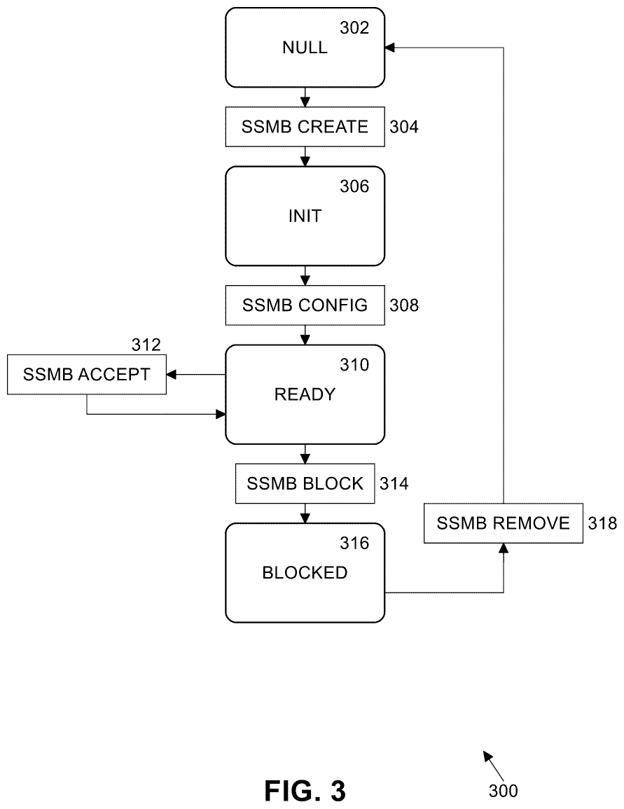

FIG. 3 illustrates a SSMB state machine 300, according to an example. The SSMB states may include Null 302, Initialized (Init) 304, Ready 310 and Blocked 316. SSMB state machine 300 represents the SSMB context, not memory pages themselves (e.g., in main memory 129 and/or secondary storage 121). SSMB 204 contains pages, and once the SSMB is in Ready 310 state, the TSM 212 enforces relaxed security properties allowing the same physical pages to be mapped to more than a single TVM at a time. In an implementation, this is reflected from the operations below named “*_PAGE_*” which align, for example, with conventional TDX private memory management APIs.

The Null 302 state means the SSMB 204 does not exist. In an implementation, the VMM 214 calls a SSMB Create 304 operation to create an instance of an SSMB, including SSMBCS 205 assigning SSMB 204 to SSMB owner 202. In an implementation, the SSMB Create operation may be a new TDX application programming interface (API) called TDH.SSMB.CREATE. The SSMB 204 then transitions to the Init 306 state.

The Init 304 state means the new instance of the SSMB has been created, but not yet configured and cannot yet be shared with SSMB users. SSMB owner 202 calls a SSMB Config 308 operation to configure access permissions (e.g., including TVM user group ID). In an implementation, the SSMB Config 308 operation may be a new TDX API called TDG.SSMB.CONFIG to configure the access attributes. SSMB owner 202 also calls a SSMB Allocate operation (not shown in FIG. 3) to allocate the SSMB memory (page by page) from the SSMB owner's own private memory space and allocate the memory to the SSMB. The SSMB Allocate operation accumulates a measurement of the HPA addresses and their corresponding locations (order) and this measurement will be used later by the TSM 212 (in the SSMB Accept operation described below) to enforce that the SSMB 204 was mapped to SSMB users in the same HPA order. In an implementation, the SSMB Allocate operation may be a new TDX API called TDG.SSMB.AUG to allocate memory. In an implementation, SSMB owner 202 may track the number of SSMB mappings for all SSMB users using a reference counter. The SSMB 204 then transitions to the Ready 310 state. The SSMB 204 is configured and can be shared with SSMB users by SSMB owner 202.

Once the untrusted VMM 214 mapped an SSMB page to a SSMB user, the SSMB user cannot access the page until the SSMB user explicitly calls an SSMB Accept 212 operation to allow the user to verify the SSMB mapping order. Access permissions are enforced by the TSM 212 (e.g., TDX module) during the mapping of the SSMB pages by the VMM to the SSMB user TVM (e.g., TD). The SSMB Accept 312 operation may accept a measurement hash from the SSMB user. As part as the SSMB accept operation, the SSMB user provides the measurement reflecting the SSMB mapping order, and optionality the contents of at least a portion of the SSMB.

The expected measurement hash may be checked by the TEE security manager 212 as pre-condition for making the SSMB page present and thus provides a mechanism for the SSMB user to ensure that SSMB mapping attributes, order and even the content matches the expected values. In an implementation, how the SSMB user gets the expected measurement may be done by exposing SSMB information stored by the SSMB owner or implicitly (for example, comparing the measurement on the last page accepted by a SSMB user). In an implementation, SSMB Accept 312 may be implemented by a new API called SSMB_Accept. In an implementation, the SSMB Accept 312 operation may be implemented by new TDX APIs called TDG.SSMB.PAGE.ACCEPT to accept the SSMB page and TDG.SSMB.PAGE.VERIFY to verify that VMM 214 correctly added the SSMB page.

The Ready 310 state means the SSMB 204 may be used by the assigned SSMB user. For example, if SSMB owner 202 has copied a downloaded disk image to the SSMB 204, then the SSMB user may copy the downloaded disk image from the SSMB to the SSMB user to use the downloaded disk image directly. This may be done by all SSMB users needing access to the SSMB.

SSMB owner 202 can remove access to the SSMB 204 when the SSMB is no longer needed. SSMB owner 202 may instruct VMM 214 to reclaim the SSMB. VMM calls a SSMB Block operation 314 to ensure the SSMB, which may still be operational, can no longer be shared with new SSMB users nor can the SSMB be used for creating new mappings of SSMB buffer pages into a SSMB user's private memory space. The SSMB now transitions to the Blocked 316 state.

In the Blocked 316 state, the VMM 214 is prohibited from creating new mappings to SSMB pages in any SSMB user TVM and must remove all SSMB mapping references from all SSMB users in order to complete the reclamation process by calling a SSMB Remove operation 318. The TSM 212 checks that all the SSMB references (e.g., mappings) were removed from all SSMB users as precondition for SSMB removal.

SSMB 204 then transitions back to the Null 302 state. To remove the SSMB, the VMM calls a new SSMB_REMOVE API and the TSM checks that there are not reference mappings to the SSMB pages in SSMB user TVMs.

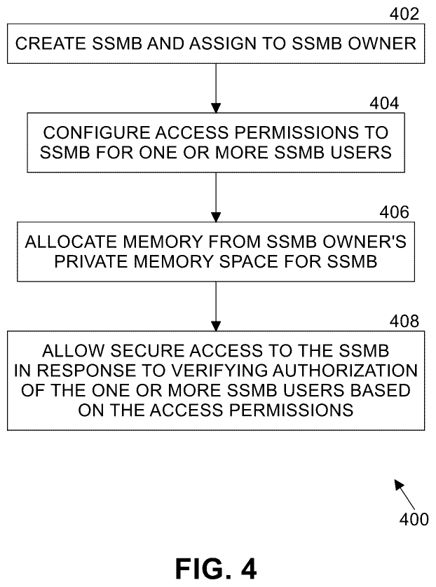

FIG. 4 is flow diagram of processing 400 for a SSMB 204, according to an example. At block 402, VMM 214 creates the SSMB 204 in the memory circuitry (e.g., main memory 120 or secondary storage 121) and assigns ownership of the SSMB to an SSMB owner 202, the SSMB owner being a TVM running on the computing system 101. At block 404, SSMB owner 202 configures access permissions for the SSMB to allow one or more SSMB users 206, 208, . . . 210 to access the SSMB, the one or more SSMB users being TVMs running on the computing system. At block 406, SSMB owner 202 allocates from the SSMB owner's private memory space in the memory circuitry for the SSMB. At block 408, one or more of the SSMB owner 202, VMM 214, and TSM 212, alone or in combination, allows secure access by the one or more SSMB users to the SSMB 204 in response to successfully verifying authorization of the one or more SSMB users based at least in part on the access permissions.

While an example manner of implementing the technology described herein is illustrated in FIGS. 1-4, one or more of the elements, processes, and/or devices illustrated in FIGS. 1-4 may be combined, divided, re-arranged, omitted, eliminated, and/or implemented in any other way. Further, the example improved computing system 101 may be implemented by hardware, software, firmware, and/or any combination of hardware, software, and/or firmware. Thus, for example, any portion or all of the improved computing system 101 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example embodiments of FIGS. 1-4 may include one or more elements, processes, and/or devices in addition to, or instead of, those illustrated in FIGS. 1-4, and/or may include more than one of any or all the illustrated elements, processes and devices.

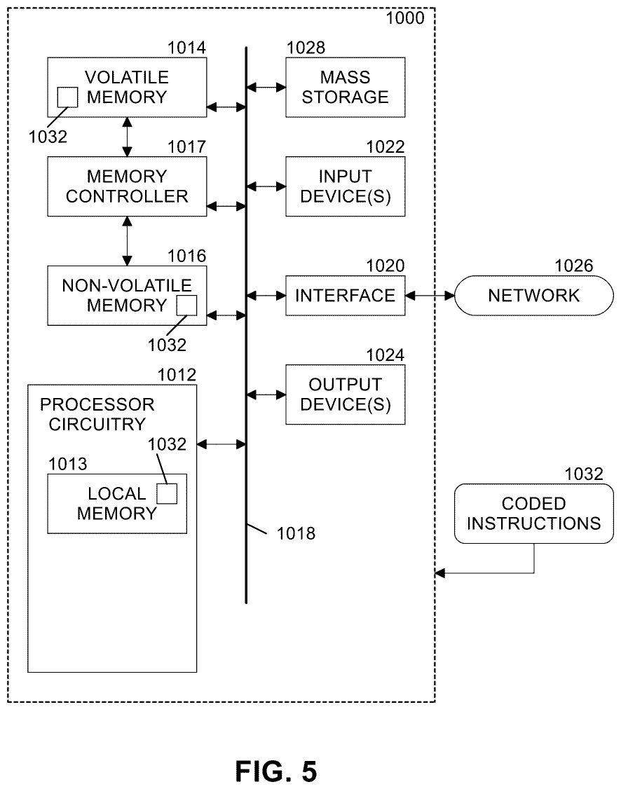

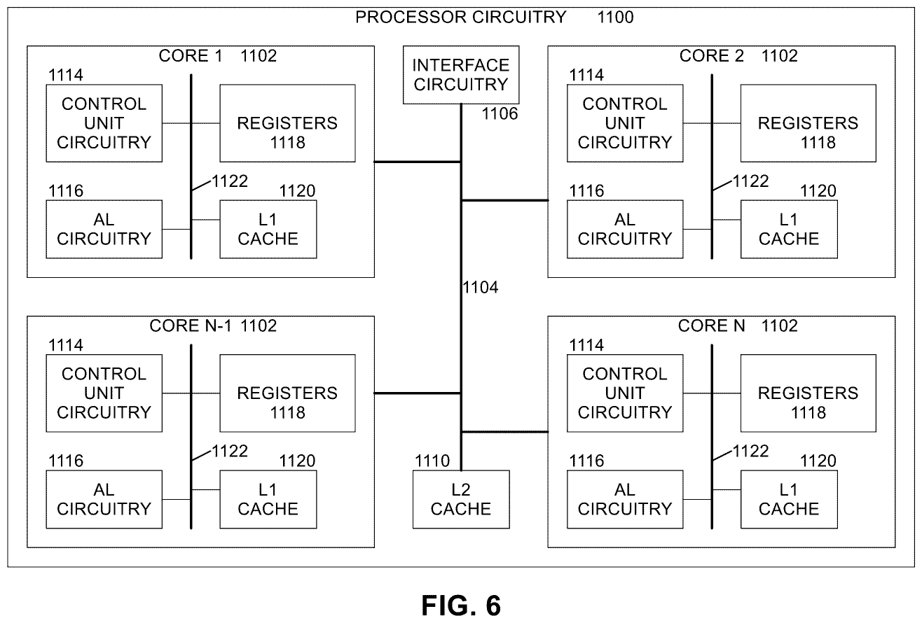

A flowchart representative of example hardware logic circuitry, machine readable instructions, hardware implemented state machines, and/or any combination thereof is shown in FIG. 4. The machine readable instructions may be one or more executable programs or portion(s) of an executable program for execution by processor circuitry, such as the processor circuitry 1012 shown in the example processor platform 1000 discussed below in connection with FIG. 5 and/or the example processor circuitry discussed below in connection with FIGS. 6 and/or 7. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 4, many other methods of implementing the example computing system may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a block diagram of an example processor platform 1000 structured to execute and/or instantiate the machine-readable instructions and/or operations of FIGS. 1-4. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example processor circuitry 122.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIGS. 1-4, may be stored in the mass storage device 1028, in the volatile memory 1014, in the non-volatile memory 1016, and/or on a removable non-transitory computer readable storage medium such as a CD or DVD.

FIG. 6 is a block diagram of an example implementation of the processor circuitry 1012 of FIG. 5. In this example, the processor circuitry 1012 of FIG. 6 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowchart of FIG. 4.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache in local memory 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 6. Alternatively, the registers 1118 may be organized in any other arrangement, format, or structure including distributed throughout the core 1102 to shorten access time. The bus 1104 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

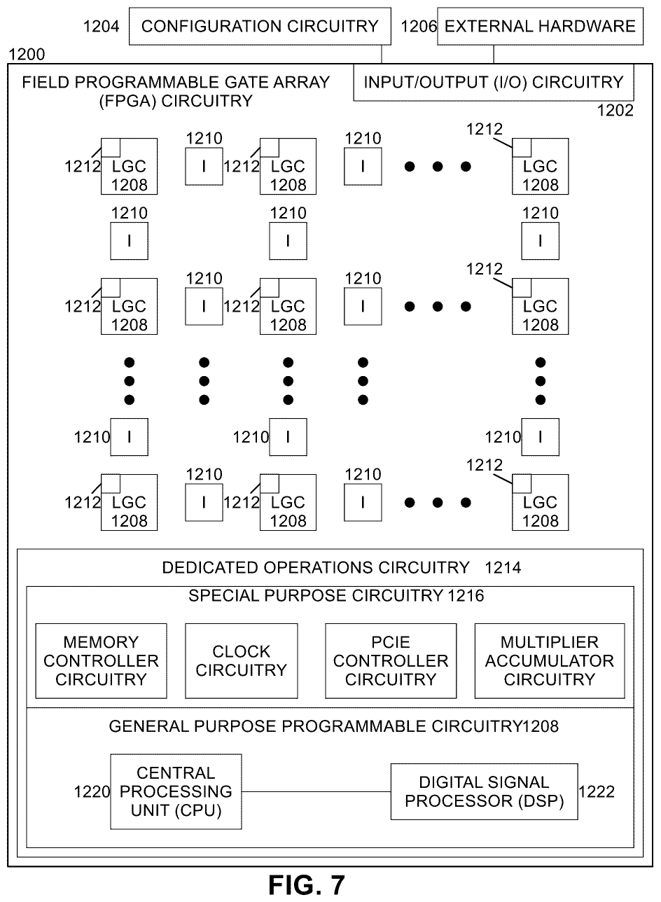

FIG. 7 is a block diagram of another example implementation of the processor circuitry 1012 of FIG. 5. In this example, the processor circuitry 1012 is implemented by FPGA circuitry 1200. The FPGA circuitry 1200 can be used, for example, to perform operations that could otherwise be performed by the example microprocessor 1100 of FIG. 6 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 6 described above (which is a general purpose device that may be programmed to execute some or all of the machine readable instructions represented by the flowchart of FIG. 4 but whose interconnections and logic circuitry are fixed once fabricated), the FPGA circuitry 1200 of the example of FIG. 7 includes interconnections and logic circuitry that may be configured and/or interconnected in different ways after fabrication to instantiate, for example, some or all of the machine readable instructions represented by the flowchart of FIG. 4. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIG. 4. As such, the FPGA circuitry 1200 may be structured to effectively instantiate some or all the machine-readable instructions of the flowchart of FIG. 4 as dedicated logic circuits to perform the operations corresponding to those software instructions in a dedicated manner analogous to an ASIC. Therefore, the FPGA circuitry 1200 may perform the operations corresponding to the some or all the machine-readable instructions of FIG. 4 faster than the general-purpose microprocessor can execute the same.

In the example of FIG. 7, the FPGA circuitry 1200 is structured to be programmed (and/or reprogrammed one or more times) by an end user by a hardware description language (HDL) such as Verilog. The FPGA circuitry 1200 of FIG. 7, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 6. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIG. 4 and/or other desired operations. The logic gate circuitry 1208 shown in FIG. 7 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 7 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 6 and 7 illustrate two example implementations of the processor circuitry 1012 of FIG. 5, many other approaches are contemplated. For example, as mentioned above, modern FPGA circuitry may include an on-board CPU, such as one or more of the example CPU 1220 of FIG. 7. Therefore, the processor circuitry 1012 of FIG. 5 may additionally be implemented by combining the example microprocessor 1100 of FIG. 6 and the example FPGA circuitry 1200 of FIG. 7. In some such hybrid examples, a first portion of the machine-readable instructions represented by the flowchart of FIG. 4 may be executed by one or more of the cores 1102 of FIG. 6 and a second portion of the machine-readable instructions represented by the flowchart of FIG. 4 may be executed by the FPGA circuitry 1200 of FIG. 7.

In some examples, the processor circuitry 1012 of FIG. 5 may be in one or more packages. For example, the microprocessor 1100 of FIG. 6 and/or the FPGA circuitry 1200 of FIG. 7 may be in one or more packages. In some examples, an XPU may be implemented by the processor circuitry 1012 of FIG. 5, which may be in one or more packages. For example, the XPU may include a CPU in one package, a DSP in another package, a GPU in yet another package, and an FPGA in still yet another package.

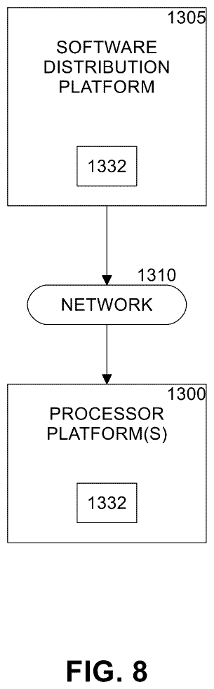

A block diagram illustrating an example software distribution platform 1305 to distribute software such as the example machine readable instructions 1032 of FIG. 5 to hardware devices owned and/or operated by third parties is illustrated in FIG. 8. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 5. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 100. In some examples, one or more servers of the software distribution platform 1305 periodically offer, transmit, and/or force updates to the software (e.g., the example machine readable instructions 1032 of FIG. 5) to ensure improvements, patches, updates, etc., are distributed and applied to the software at the end user devices.

In some examples, an apparatus includes means for data processing of FIGS. 1-4. For example, the means for processing may be implemented by processor circuitry, processor circuitry, firmware circuitry, etc. In some examples, the processor circuitry may be implemented by machine executable instructions executed by processor circuitry, which may be implemented by the example processor circuitry 1012 of FIG. 5, the example microprocessor 1100 of FIG. 6, and/or the example Field Programmable Gate Array (FPGA) circuitry 1200 of FIG. 7. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide improved performance for security in a computing system. The disclosed systems, methods, apparatus, and articles of manufacture improve the performance of implementing a SSMB 204 in a computing system. The disclosed systems, methods, apparatus, and articles of manufacture are accordingly directed to one or more improvement(s) in the operation of a machine such as a computer or other electronic and/or mechanical device.

The following examples pertain to further embodiments. Specifics in the examples may be used anywhere in one or more embodiments. Example 1 is a computing system including memory circuitry to store a secure shared memory buffer (SSMB) and instructions; and a processor coupled to the memory circuitry to execute the instructions to create the SSMB in the memory circuitry and assign ownership of the SSMB to an SSMB owner, the SSMB owner including a trusted execution environment virtual machine running on the computing system; configure access permissions for the SSMB by the SSMB owner to allow one or more SSMB users to access the SSMB, the one or more SSMB users including trusted execution environment virtual machines running on the computing system; allocate memory by the SSMB owner from a private memory space of the SSMB owner in the memory circuitry for the SSMB; and allowing secure access by the one or more SSMB users to the SSMB in response to successfully verifying authorization of the one or more SSMB users based at least in part on the access permissions.

In Example 2, the subject matter of Example 1 optionally includes wherein the SSMB is securely shared among multiple SSMB users. In Example 3, the subject matter of Example 1 optionally includes the SSMB owner to control creation of the SSMB, deletion of the SSMB, and setting and revoking access permissions of the one or more SSMB users for the SSMB. In Example 4, the subject matter of Example 1 optionally includes wherein the SSMB owner and the one or more SSMB users are trusted domains (TDs) in a trusted domain extension (TDX) computing architecture. In Example 5, the subject matter of Example 1 optionally includes a trusted execution environment security manager running on the computing system to verify the authorization of the one or more SSMB users. In Example 2, the subject matter of Example 1 optionally includes an untrusted virtual machine manager to create the SSMB. In Example 7, the subject matter of Example 1 optionally includes wherein the SSMB comprises a selected ordered set of host physical address pages allocated from a private guest physical address space of the SSMB owner. In Example 8, the subject matter of Example 1 optionally includes wherein the selected ordered set of host physical address pages can be allocated to only one SSMB. In Example 9, the subject matter of Example 1 optionally includes wherein the one or more SSMB users share a key domain with the SSMB owner.

Example 10 is a method including creating a secure shared memory buffer (SSMB) in a memory of a computing system and assigning ownership of the SSMB to an SSMB owner, the SSMB owner including a trusted execution environment virtual machine (TVM) running on the computing system; configuring access permissions for the SSMB by the SSMB owner to allow one or more SSMB users to access the SSMB, the one or more SSMB users including TVMs running on the computing system; allocating memory by the SSMB owner from a private memory space of the SSMB owner in the memory for the SSMB; and allowing secure access by the one or more SSMB users to the SSMB in response to successfully verifying authorization of the one or more SSMB users based at least in part on the access permissions.

In Example 11, the subject matter of Example 10 optionally includes securely sharing access to the SSMB among multiple SSMB users. In Example 12, the subject matter of Example 10 optionally includes controlling, by the SSMB owner, creation of the SSMB, deletion of the SSMB, and setting and revoking access permissions of the one or more SSMB users for the SSMB. In Example 13, the subject matter of Example 10 optionally includes verifying, by a trusted execution environment security manager (TSM) running on the computing system, the authorization of the one or more SSMB users. In Example 14, the subject matter of Example 10 optionally includes creating the SSMB by an untrusted virtual machine manager. In Example 15, the subject matter of Example 10 optionally includes wherein the SSMB comprises a selected ordered set of host physical address pages allocated from a private guest physical address space of the SSMB owner. In Example 16, the subject matter of Example 15 optionally includes wherein the selected ordered set of host physical address pages can be allocated to only one SSMB. In Example 17, the subject matter of Example 10 optionally includes wherein the one or more SSMB users share a key domain with the SSMB owner.

Example 18 is at least one machine-readable storage medium comprising instructions which, when executed by at least one processor, cause the at least one processor to create a secure shared memory buffer (SSMB) in a memory of a computing system and assigning ownership of the SSMB to an SSMB owner, the SSMB owner including a trusted execution environment virtual machine (TVM) running on the computing system; configure access permissions for the SSMB by the SSMB owner to allow one or more SSMB users to access the SSMB, the one or more SSMB users including TVMs running on the computing system; allocate memory by the SSMB owner from a private memory space of the SSMB owner in the memory for the SSMB; and allow secure access by the one or more SSMB users to the SSMB in response to successfully verifying authorization of the one or more SSMB users based at least in part on the access permissions.

In Example 19, the subject matter of Example 18 optionally includes instructions which, when executed by at least one processor, cause the at least one processor to securely share access to the SSMB among multiple SSMB users. In Example 20, the subject matter of Example 18 optionally includes instructions which, when executed by at least one processor, cause the at least one processor to control, by the SSMB owner, creation of the SSMB, deletion of the SSMB, and setting and revoking access permissions of the one or more SSMB users for the SSMB.

Example 21 is an apparatus operative to perform the method of any one of Examples 10 to 17. Example 22 is an apparatus that includes means for performing the method of any one of Examples 10 to 17. Example 23 is an apparatus that includes any combination of modules and/or units and/or logic and/or circuitry and/or means operative to perform the method of any one of Examples 10 to 17. Example 24 is an optionally non-transitory and/or tangible machine-readable medium, which optionally stores or otherwise provides instructions that if and/or when executed by a computer system or other machine are operative to cause the machine to perform the method of any one of Examples 10 to 17.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

1.-20. (canceled)

21. An apparatus comprising:
processor circuitry to:
configure access permissions relating to a secure buffer to allow one or more user entities to access the secure buffer, wherein the one or more user entities include one or more virtual machines;
allocate memory space to the secure buffer; and
allowing secure access to the secure buffer to the one or more user entities in response to successfully verifying the one or more user entities and authorizing the one or more user entities to access the secure buffer.

22. The apparatus of claim 21, wherein the processor circuitry is further to create the secure buffer and assign ownership of the secure buffer to a secure buffer owner, wherein the secure buffer is securely shared by multiple users, wherein the one or more virtual machines include one or more trusted execution environment (TEE)-based virtual machines.

23. The apparatus of claim 21, wherein the processor circuitry is further to control the secure buffer, wherein to control includes creating the secure buffer, deleting the secure buffer, setting and revoking the access permissions to the secure buffer.

24. The apparatus of claim 21, wherein the secure buffer owner and the one or more user entities relate to one or more trusted domains (TDs), wherein the one or more TDs to verify and authorize the one or more user entities.

25. The apparatus of claim 21, wherein the secure buffer comprises a selected ordered set of host physical address pages allocated from a private guest physical address space relating to the secure buffer owner, and wherein the one or more user entities share a key domain with the secure buffer owner, wherein the processor circuitry is coupled to a memory, the processor circuitry including one or more of application processor circuitry or graphics processor circuitry.

26. A method comprising:
configuring, by a computing device, access permissions relating to a secure buffer to allow one or more user entities to access the secure buffer, wherein the one or more user entities include one or more virtual machines;
allocating memory space to the secure buffer; and
allowing secure access to the secure buffer to the one or more user entities in response to successfully verifying the one or more user entities and authorizing the one or more user entities to access the secure buffer.

27. The method of claim 26, further comprising creating the secure buffer and assign ownership of the secure buffer to a secure buffer owner, wherein the secure buffer is securely wherein the secure buffer is securely shared by multiple users, wherein the one or more virtual machines include one or more trusted execution environment (TEE)-based virtual machines.

28. The method of claim 26, further comprising controlling the secure buffer, wherein to control includes creating the secure buffer, deleting the secure buffer, setting and revoking the access permissions to the secure buffer.

29. The method of claim 26, wherein the secure buffer owner and the one or more user entities relate to one or more trust domains (TDs), wherein the one or more TDs to verify and authorize the one or more user entities

30. The method of claim 26, wherein the secure buffer comprises a selected ordered set of host physical address pages allocated from a private guest physical address space relating to the secure buffer owner, and wherein the one or more user entities share a key domain with the secure buffer, wherein the computing device includes a processor having one or more of an application processor or a graphics processor.

31. At least one computer-readable medium having stored thereon instructions which, when executed, cause a computing device to perform operations comprising:
configuring access permissions relating to a secure buffer to allow one or more user entities to access the secure buffer, wherein the one or more user entities include one or more virtual machines;
allocating memory space to the secure buffer; and
allowing secure access to the secure buffer to the one or more user entities in response to successfully verifying the one or more user entities and authorizing the one or more user entities to access the secure buffer.

32. The computer-readable medium of claim 31, wherein the operations further comprise creating the secure buffer and assign ownership of the secure buffer to a secure buffer owner, wherein the secure buffer is securely wherein the secure buffer is securely shared by multiple users, wherein the one or more virtual machines include one or more trusted execution environment (TEE)-based virtual machines.

33. The computer-readable medium of claim 31, wherein the operations further comprise controlling the secure buffer, wherein to control includes creating the secure buffer, deleting the secure buffer, setting and revoking the access permissions to the secure buffer.

34. The computer-readable medium of claim 31, wherein the secure buffer owner and the one or more user entities relate to one or more trust domains (TDs), wherein the one or more TDs to verify and authorize the one or more user entities

35. The computer-readable medium of claim 31, wherein the secure buffer comprises a selected ordered set of host physical address pages allocated from a private guest physical address space relating to the secure buffer owner, and wherein the one or more user entities share a key domain with the secure buffer, wherein the computing device includes a processor having one or more of an application processor or a graphics processor.
